(19) United States
(12) Patent Application Publication
(10) Pub. No.: US 2002/0194275 A1
(43) Pub. Date: Dec. 19, 2002

(54) Work support information extracting program and work support information extracting system using thereof

(76) Inventors: Shigetoshi Sakimura, Hitachi (JP); Hisanori Nonaka, Tokai (JP); Hiroyuki Satake, Hitachi (JP); Hiroshi Shojima, Hitachiota (JP); Takeshi Yokota, Hitachi (JP); Atsushi Ishll, Hitachi (JP); Toshio Hata, Hitachinaka (JP); Masao Teratani, Tokyo (JP); Hideo Ozawa, Matsudo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/035,149

(22) Filed: Jan. 4, 2002

(30) Foreign Application Priority Data
Jun. 18, 2001 (JP) 2001-183661

(51) Int. Cl. G06F 15/16

(52) U.S. Cl. 709/205

(57) ABSTRACT

A work support information extraxting proram and a work support information extracting system unsing thereof assist to extract the work support information by inputting the staff/organization DB containing the organization structure and staff structure in the staff/organization DB input process, extracting the work DB containing the work item, work carrying-out unit and work carrying-out condition, and generating the work support flow data, well-coordinated throughout the organization, from the staff/organization DB and work DB in the work support flow generating process.

### BACKGROUND OF THE INVENTION

The present invention relates to a work support system for guiding the schedule and procedure of work in general enterprises or governmental offices, particularly to a work support information extracting program for generating a work support flow to be used for work support purpose on a work support unit and also to a work support information extracting system using the program.

Conventionally, a workflow system has been employed as a system for supporting typical or routine work. The workflow system is provided with a function that defines predetermined work procedures as workflow data and makes guidance for the schedule and ways of carrying out the work according to the defined data. Workflow generation support system is a system for generating the workflow data.

A workflow generation support system is disclosed in Japanese Application Patent Laid-open Publication No. HEI 07-249024, HEI 08-287157 and so on, and the system is capable of defining work items, work carrying-out condition, and work carrying-out sequence. Way of defining the above differs from a system to another, out of which some (Japanese Application Patent Laid-open Publication No. 08-287157) indicates the work carrying-out sequence in a visual way where nodes are connected with arrows and some (Japanese Application Patent Laid-open Publication No. HEI 07-249024) indicates the work items in a list form where priorities are given to the items.

Japanese Application Patent Laid-open Publication No. HEI 10-326306 describes a task assignment system, where the tasks assigned to a class, to which a worker belongs, and also to a higher class are assigned to the worker. Besides, Japanese Application Patent Laid-open Publication No. HEI 08-161393 discloses a work system that is provided with a work environment editing function, hence flexible for any change in the work environment, work description and organization.

The conventional workflow generation support system is capable of defining the work item, work carrying-out condition and work carrying-out sequence. However, there arises a problem that different workflow writers may describe the workflow of a same work in different grading because the system is not provided with a standard for determining the unit (or preciseness) of work item.

When an organization A has, for example, a piece of work called “Request for Order”, comprising two pieces of work called “Preparation of Order” and “Section Manager's approval on Order”, and a workflow is to be described for this, one writer may describe the workflow in which the work “Section Manager's approval on Order” be carried out after the work “Preparation of Order” is completed but another writer may describe the workflow which completes with a single piece of work “Request for Order”.

With a workflow generation support system disclosed in Japanese Application Patent Laid-open Publication No. HEI 07-249024, Japanese Application Patent Laid-open Publication No. HEI 10-326306, etc., there arises a problem that, if a work is to be carried out jointly by multiple organizations, partial modification of the workflow as a result of personnel changes and/or organization changes affects other workflows because the priority of sequence can be defined directly to the work of a different organization.

Here, an assumption is made that, for example, the work called “Ordering” is required in a different organization B after the work “Section Manager's approval on Order” in the previous case. If the work “Department Manager's approval on Order” is further needed after the work “Section Manager's approval on Order”, the following will happen.

If the above modification is made by the organization A which carries out the work “Request for Order”, the workflow is so changed by the organization A that the work “Department Manager's approval on Order” is carried out after “Section Manager's approval on Order”. To modify the workflow correctly, however, the carrying-out condition of “Ordering” must also be changed from “Section Manager's approval on Order” completed to “Department Manager's approval on Order” completed. If a workflow writer in the organization A is not well aware of the work in an external organization B, there is no guarantee that the carrying-out condition of the work “Ordering” taken charge by the organization B is modified correctly. This problem becomes more serious as the carrying-out condition of the work “Ordering” becomes more complicated.

Besides, a workflow generation support system disclosed in Japanese Application Patent Laid-open Publication No. HEI 08-287157 is provided with a function for describing classified workflows but with no standard for determining the work class, that is, what range of work items carried out in individual classes should be assigned to each roughly defined class. As a result, there arises a problem that different workflow writers may describe different work class information.

With a work system described in Japanese Application Patent Laid-open Publication No. HEI 08-161393, on the other hand, a user must describe the relationship of work items between different classes in a direct manner because the system is not provided with a function for describing classified workflows. As a result, maintenance of the workflows is difficult.

In short, with a conventional workflow generation support system, describing a workflow requires a task dependent upon the writer's subjectivity and, because of this, there arises a problem that only an expert writer can describe the workflow or that the described workflow cannot be modified.

### SUMMARY OF THE INVENTION

An object of the present invention, where there is provided a function for describing the classified workflows, is to offer a work support information extracting program and a work support information extracting system using the program which provides a workflow writer with an objective standard for determining the work item unit and work class.

Another object of the present invention, where there is provided a function for describing the classified workflows, is to offer a work support information extracting program and a work support information extracting system using the program in which modification of some workflows does not produce effect on the other workflows.

In order to solve the problems above, the work support information extracting program according to the present invention is to be executed on a computer comprising a data processing unit, a storage unit containing a staff/organization database, and an input-output unit; the work support information extracting program is provided with a work extracting function that stores an inputted work database into the storage unit and a work support flow generating function that generates work support flow data from the information in the staff/organization database and work database and stores the data into the storage unit as well; and the work support flow generating function is provided with a function that generates, from the workflows in an organizational class stored in the work database and class information stored in the staff/organization database, the work carrying-out condition information applicable to multiple organizational classes.

The work support information extracting system according to the present invention is constructed of a work support information extracting program that executes a staff/organization database (hereinafter called staff/organization DB) inputting function that inputs the staff/organization DB containing the organization information about the class structure of the organization that carries out the work and the staff information about the staff who constitutes the organization and carries out the work; a work extracting function that inputs the work database (hereinafter called the work DB) containing the work item information, work carrying-out condition information that indicates the sequences and conditions of carrying out the work, and work carrying-out unit information that indicates the person(s) or organization(s) in charge of carrying out the work; and a work support flow generating function that generates the work support flow data from the information in the staff/organization DB and work DB; and a storage unit that stores the staff/organization DB, work DB, and work support flow data; an input unit that executes, out of the functions executed by the work support information extracting program, a receiving function of inputs from the user of the system; and the functions executed by the work support information extracting program.

With a work support information extracting program according to the present invention and a unit using the program, where there is provided a function for describing the classified workflows, work can be extracted in a unit corresponding to the unit of staff/organization structure. In addition, the effect of modifying a workflow can be limited within the organization which carries out the work so that modifying a workflow in an organizational class results in no effect on the workflow of other organizational classes.

According to the present invention, a user can modify the work system applicable to multiple organizations or classes by defining only the sequence in the organization or class.

### BRIEF DESCRIPTION OF DRAWINGS

FIG. 1

An example of the work support information extracting program according to the first embodiment of the present invention

FIG. 2

A diagram showing the construction of the work support information extracting unit according to the first embodiment of the present invention

FIG. 3

A diagram showing the format and an example of the staff/organization DB in the first embodiment

FIG. 4

A diagram showing an example of the input screen of the staff/organization DB in the first embodiment

FIG. 5

A flowchart showing the internal process of the work extracting process in the first embodiment

FIG. 6

A flowchart showing the internal process of the sub-work carrying-out unit extracting process in the first embodiment

FIG. 7

A flowchart showing the internal process of the sub-work carrying-out condition extracting process in the first embodiment

FIG. 8

A diagram showing the format and an example of the work DB in the first embodiment

FIG. 9

A diagram showing an example of the work data input screen (for a case where the workflow contains no branch) in the first embodiment

FIG. 10

A diagram showing an example of the work data input screen (for a case where the workflow contains a branch) in the first embodiment

FIG. 11

A flowchart showing the internal process of the sub-class workflow completion condition generating process in the first embodiment

FIG. 12

A diagram showing the format and an example of the workflow completion condition table in the first embodiment

FIG. 13

A diagram showing an example of the input screen of the sub-class workflow completion condition in the first embodiment

FIG. 14

A flowchart showing the internal process of the work support flow generating process in the first embodiment

FIG. 15

A flowchart showing the internal process of the highest-class work searching process in the first embodiment

FIG. 16

A diagram showing the format and an example of the work support flow data

FIG. 17

A diagram showing the data structure in the work support information extracting service according to the second embodiment of the present invention

FIG. 18

A flowchart showing an example of the work support information extracting program in the second embodiment

FIG. 19

A diagram showing the data updating in the work support information extracting service in the second embodiment

FIG. 20

A diagram showing an example of the enterprise DB in the second embodiment

FIG. 21

A diagram showing an example of the integrated enterprise DB in the second embodiment

FIG. 22

A diagram showing an example of the integrated work support flow data in the second embodiment

### DETAILED DESCRIPTION OF THE EMBODIMENTS

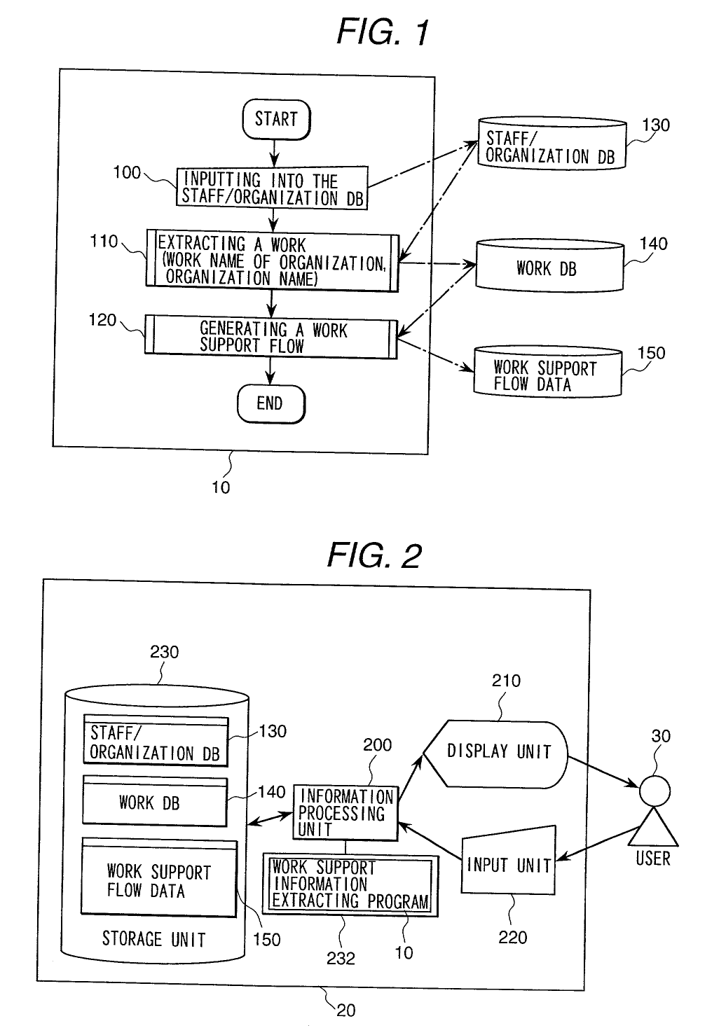

The first preferred embodiment of the present invention is explained hereunder, using FIG. 1 to FIG. 16. To start with, the work support information extracting system of the first embodiment is explained, using FIGS. 1 and 2.

The work support information extracting program 10 for the work support information extracting system of the present invention comprises the staff/organization DB inputting process 100 that inputs the staff/organization data into the staff/organization DB 130, work extracting process 110 that input the work data into the work DB 140, and work support flow generating process 120 that automatically generates the work support flow data 150 from the information stored in the staff/organization DB 130 and work DB 140. In this embodiment, the work support information extracting program 10 is executed by a work support information extracting unit 20 in FIG. 2. That is, the work support information extracting unit 20 comprises an information processing unit 200, display unit 210, input unit 220, and storage units 230, 232, and the work support information extracting program 10 is stored in the storage unit (or storage medium) 232 and executed on the information processing unit 200 or the like.

In FIG. 1, the staff/organization inputting process 100 inputs the staff data and organization data in accordance with the data format of the staff/organization DB, and stores the data in the staff/organization DB. Any means of input is acceptable. For example, data can be inputted from the staff/organization DB input screen 400, to be explained later, or necessary staff data and organization data can be read out from a staff/organization file prepared separately.

Next, the work extracting process 110 inputs the information about the work that is subdivided by a staff unit and organization unit in accordance with the data in the staff/organization DB, and stored the data in the work DB. Since the work is subdivided by class, for example, subdivided into the the highest-class organization work, the second highest-class organization work, the third highest-class organization work, and so on in this process, the work name and organization name of the highest-class organization is handed over to the work extracting process 110. Detailed explanation of the work extracting process 110 will be given later.

Lastly, the work support flow generating process 120 generates the work support flow data, which is the final work support data, from the data in the staff/organization DB and work DB. Detailed explanation of the work support flow generating process 120 will be given later.

In the processes in steps 100 to 120 as above, work-related information corresponding to a staff unit or organization unit is inputted by the user and the work flow in an organization is also inputted by the user independently from that in other organizational classes. Thus, the program produces a result that the work support flow data applicable to multiple organizational classes is generated.

Detailed explanation of the data format of the staff/organization DB 130, work DB 140 and work support flow data 150 will be given later.

Next, the construction of the work support information extracting unit 20, on which the work support information extracting program 10 is executed, is explained hereunder, using FIG. 2.

The information processing unit 200 reads out the work support information extracting program 10 from the storage unit (or storage medium) 232 and executes the processes other than those executed by the display unit 210 and input unit 220.

The display unit 210 executes such processes that relate to display to the user 30, of the information extracting program 10. To be concrete, those are displaying the staff/organization DB input screen 400, displaying the work data input screen 900, and displaying the sub-class workflow completion condition input screen 1300, each to be explained later.

Of the processes executed in the work support information extracting program 10, the input unit 10 executes such processes that are relate input by the user 30. To be concrete, those are inputting into the staff/organization DB input screen 400, inputting into the work data input screen 900, and inputting into the sub-class workflow completion condition input screen 1300, each to be explained later.

The staff/organization DB 130, work DB 140 and work support flow data 150 are stored in the storage unit 230, and each data is processed, displayed or inputted in each process on the information processing unit 200, display unit 210 and input unit 220.

With the above construction, there is provided an effect that processing of the work support information extracting program 10, input of data from the user into the work support information extracting program 10, display of data from the work support information extracting program 10 to the user, and storage of data resulting from the process of the work support information extracting program 10 can be all realized.

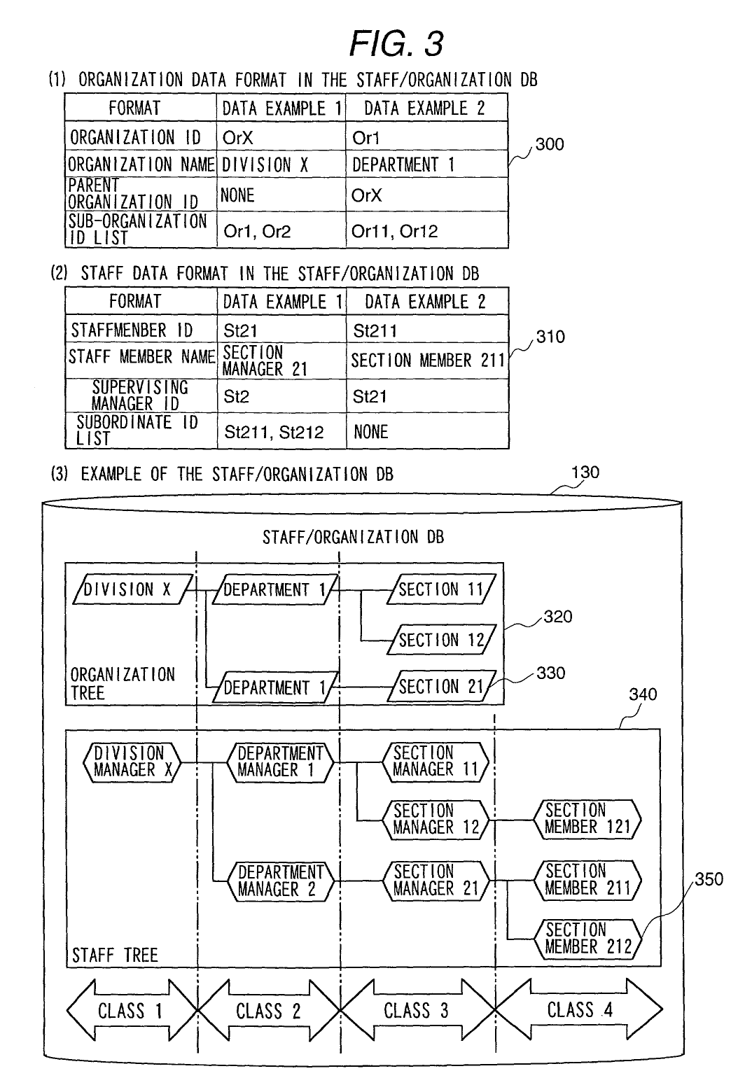

Next, FIG. 3 shows the data format of the staff/organization DB 130. The staff/organization DB 130 contains an organization tree 320, which is the organizational class information, and a staff tree 340, which is the staff class information, each contained class data in a tree structure. The organization tree 320 contains the organization data 330 as nodes in the tree structure, and the staff tree 340 contains the staff data 350 as nodes in the tree structure.

FIG. 3(1) shows the format of the organization data. The elements of the organization data format 300 include organization ID, organization name, parent organization ID, and sub-organization ID, where the organization ID contains an ID for identifying the organization uniquely, the organization name contains the name of the organization, the parent organization ID contains an ID of an organization that is the parent organization in the organization data, and the sub-organization ID list contains a list of IDs of organizations that are the sub-organizations in the organization data, respectively.

This embodiment employs the parent organization ID and sub-organization ID list as the data indicating the tree-structured class, but other type of data is acceptable. For example, a pointer to the parent organization data can be used in place of the parent organization ID and pointers to the sub-organization data can be stored in place of the sub-organization ID.

FIG. 3(2) shows the format of the staff data. The elements of the staff data format 310 include staff member ID, staff member name, supervising manager ID, and subordinate ID list, where the staff member ID contains an ID for identifying the staff member uniquely, the staff member name contains the name of the staff member, the supervising manager ID contains an ID of a manager who is the supervising manager in the staff data, and the subordinate ID list contains a list of IDs of staff members who are the subordinates in the staff data. The name of the staff member above indicates either the name of a person or the title of a position, and the name of a person is used as the staff member name in this embodiment.

This embodiment employs the supervising manager ID and subordinate ID list as the data indicating the tree-structured class, but other type of data is acceptable. For example, a pointer to the supervising manager data can be used in place of the supervising manager ID and pointers to the subordinate data can be used in place of the subordinate ID list.

FIG. 3(3) shows an example of the staff/organization DB. This example shows an organization structure, where Division X, which is the highest class organization, has sub-organizations Department 1 and Department 2, Department 1 has sub-organizations Section 11 and Section 12, and Department 2 has a sub-organizatio Section 21. It also shows a staff structure, where each class has a manager like Division Manager X in Division X and each Section 12 and Section 21 has a Section member(s). In this embodiment, the organization structure and staff structure are presented as a classified tree structure as above.

With the data format as above, there is provided an effect that the organization data and staff data of a class structure can be maintained.

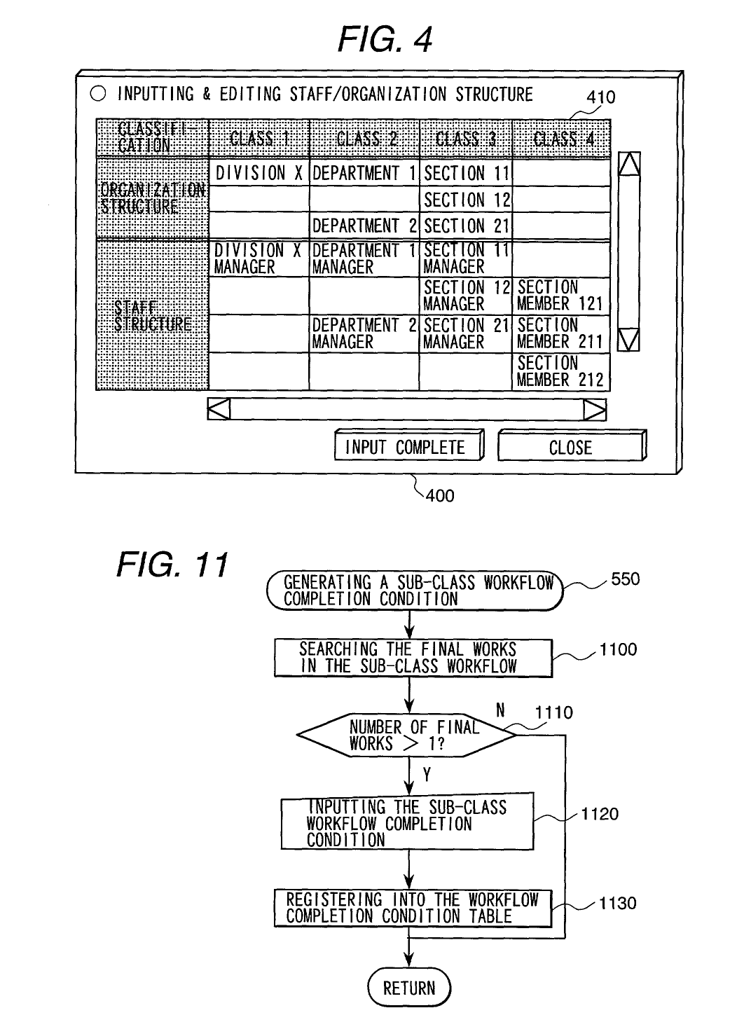

Next, FIG. 4 shows an example of the screen in the staff/organization DB inputting process 100. A spread sheet entry is employed for data input in this example, and the organization tree data and staff tree data can be inputted in the staff/organization structure input frame 410. Each of the first column and the first row (shaded) of the frame represents the index of the columns and rows, respectively. Inputting each data into the spread sheet constructs the staff/organization DB.

In case the data of a staff and organization structure shown in FIG. 3(3) is to be inputted, input a corresponding set of data of the Division name, Department name and Section name, and also the Division manager name, Department Manager name, Section Manager name, and Section member name into each class in the staff/organization structure input frame 400. The data for each class inputted in the same row is regarded to have a hierarchical relation.

For example, as Division X, Department 1 and Section 11 are inputted in the same row in an example in FIG. 4, the organization data of Department 1 is regarded to have a hierarchical relation that Division X is the parent organization and Section 11 is one of the sub-organizations. If a parent element has two or more sub-elements, a cell (or cells) just below the parent element cell is (are) left blank and the second sub-element (or more sub-elements) is (are) inputted in the cell (or in each cell) on the right. For example, in an example in FIG. 4 where Department 1, the parent element has two sub-elements, Section 11 and Section 12, a cell just below the cell used for inputting Department 1 is left blank, and Section 12, the second sub-element is inputted in the cell on the right. A similar manner applies to the input of the staff structure. When an organization name is inputted into each cell, an organization ID for identifying the organization uniquely is generated automatically and, when a staff member name is inputted, a staff member ID for identifying the staff member uniquely is generated automatically. Both columns and rows of the staff/organization structure input frame 410 can be added or deleted so as to cope with possible increase or decrease of the classes, staff members and organizations.

A spread sheet entry is employed for data input in the example in FIG. 4 but any other entry is acceptable. For example, it is acceptable to employ a visual entry where the staff/organization elements are represented by symbols like circle and square and the symbols are connected with each other with lines.

With the example screen as above, there is provided an effect that the staff/organization data corresponding to the data format of the staff/organization DB can be inputted.

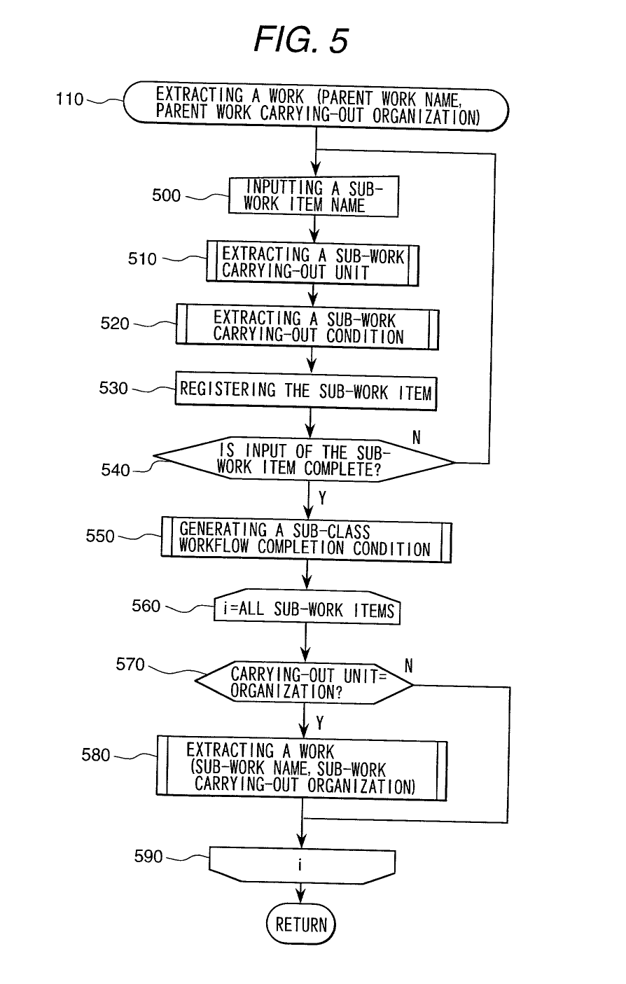

Next, FIG. 5 shows the detailed sequence of the work extracting process 110. Since the work extracting process 110 is a recursive type program, the call origin process of this process hands over the parent work name and parent work carrying-out organization name as the data necessary for this process. The work extracting process 110 is provided with a function that extracts the sub-works and sub-work carrying-out staff members (or organizations), which constitute the “parent work” carried out by the “parent work carrying-out organization” received from the call origin. That is, it is a function that subdivides the parent work at the call origin into two or more sub-works.

The process sequence is explained concretely hereunder.

After the parent work name and parent work carrying-out organization name as the handed-over data are received from the call origin, the sub-work item name constituting the parent work (step 500) is inputted. Next, the extracting process of the sub-work carrying-out unit corresponding to the inputted sub-work name (step 510) is executed. Then, the extracting process of the sub-work carrying-out condition corresponding to the inputted sub-work name (step 520) is also executed. The sub-work carrying-out condition means a condition of carrying out the sub-work, for example, “after what work the sub-work should be carried out” or “under what condition the sub-work should be carried out”.

Since necessary data for the work item has become available through the processes above, the inputted work item is registered into the work DB (step 530). As a result of the processes above, a work item for which a staff member or organization has been specified as the carrying-out unit, i.e, a work item subdivided by staff unit or organization unit has been inputted.

The processes above are repeated until all sub-work items are inputted (step 540). Multiple sub-work items subdivided from the parent work are all inputted through this process.

When multiple sub-works corresponding to the parent work are inputted at a point where the process up to step 540 is complete, it is likely to happen that the parent work comes to completion while the workflow comprising the carrying-out sequences of the sub-works is branched. For example, when a parent work “Request for Order” comes to completion with two sub-works “Section Manager's approval on Order” and “Department Manager's approval on Order”, the condition of completing the workflow in the sub-class can be either a case where “Section Manager's approval on Order” is completed and “Department Manager's approval on Order” is also completed or a case where either one of “Section Manager's approval on Order” and “Department Manager's approval on Order” is completed. In case the workflow completion condition in the sub-class cannot be defined uniquely like the above, a process for inputting the completion condition is then executed (step 550).

Through the process up to step 550, the workflow in the sub-class corresponding to the parent work is determined.

Next, for all the sub-works constituting the subclass workflow, whether the carrying-out unit is a person or an organization is checked (steps 560, 570). If the carrying-out unit is an organization, the work is judged capable of being further subdivided and the work extracting process 110 is called recursively (step 580). The data to be handed over to the recursive call destination is the name and carrying-out organization of the work which carrying-out unit is found to be an organization.

The processes in steps 570 and 580 are repeated on all sub-works constituting the sub-class workflow (step 590) and the work extracting process 110 is complete.

Detailed explanation of the sub-work carrying-out unit extracting process 510, sub-work carrying-out condition extracting process 520 and sub-class workflow completion condition generating process 550 will be given later.

Through the processes in steps 500 to 590, there is provided an effect that the work items by a unit corresponding to the staff or organization are inputted by the user, the carrying-out person or organization is determined for each work item, and that the workflow within the organization is inputted independently in each organizational class.

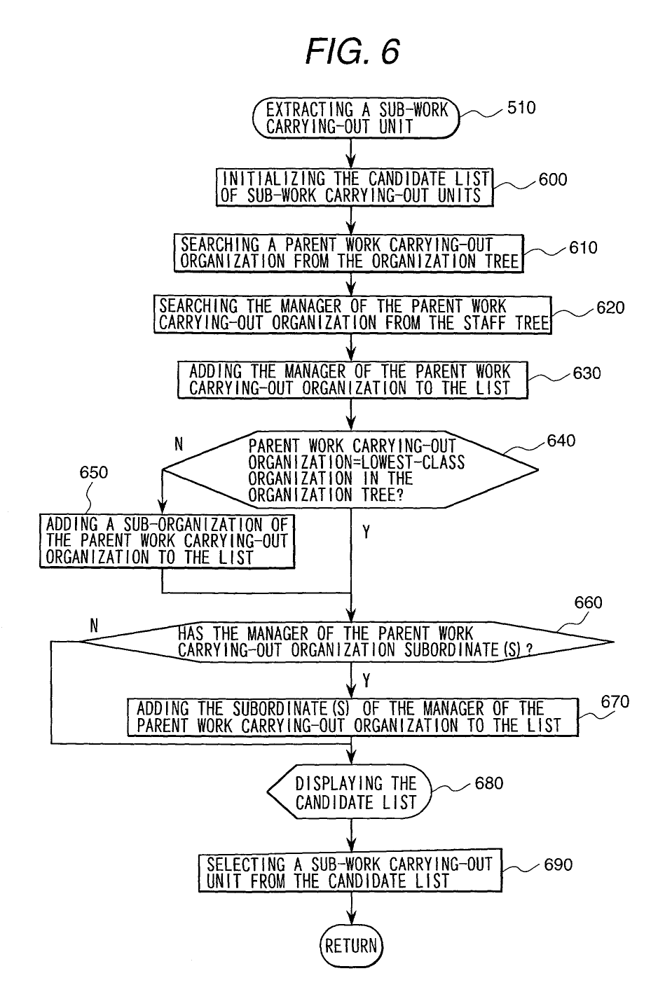

Next, FIG. 6 shows the detailed sequence of the sub-work carrying-out unit extracting process 510. The sub-work carrying-out unit extracting process 510, which is a process that determines the person or organization carrying out the sub-work item inputted in the work extracting process 110, is provided with a function of generating a candidate list of the carrying-out units dynamically.

The process sequence is explained concretely hereunder. To start with, a list for storing the candidate carrying-out units of the sub-work is first initialized (step 600), and a parent work carrying-out organization is searched from the organization tree in the staff/organization DB and the manager of the parent work carrying-out organization is searched from the staff tree of the staff/organization DB (steps 610, 620). Next, the manager of the parent work carrying-out organization is added to the candidate list (step 630).

That is to say, there is a possibility that a sub-work constituting the parent work is carried out by the manager of the parent work carrying-out organization. For example, a work within Division X, constituting the Division X work, may possibly be taken charge by Division Manager X.

Next, at what class the parent work carrying-out organization is positioned in the organization tree is checked. To be concrete, whether the organization is at the lowest class (=bottom class) in the organization tree is checked (step 640). If the parent work carrying-out organization is found to be not at the bottom class as a result of the check, it means that there is a lower class organization than the parent work carrying-out organization, and therefore, the sub-organization of the parent work carrying-out organization is added to the candidate list (step 650).

That is to say, there is a possibility that a sub-work constituting the parent work is carried out by the sub-organization of the parent work carrying-out organization. For example, a work within Division X constituting the Division X work may possibly be taken charge by the sub-organization of Division X, such as Department 11 or Department 12.

Next, whether the manager of the parent work carrying-out organization has subordinate is checked (step 660). If the manager is found to have a subordinate(s) as a result of the check, the subordinate is added to the candidate list (step 670)

That is to say, there is a possibility that a sub-work constituting the parent work is carried out by the subordinate of the manager of the parent work carrying-out organization. For example, a work within Division X, constituting the Division X work, may possibly be taken charge by Department Manager 11 or Department Manager 12 who is a subordinate of Division Manager X.

Through the process up to step 670, the candidate list of the sub-work carrying-out units is determined. In other words, a sub-work constituting the parent work is carried out by any of the manager of the parent work carrying-out organization, its sub-organization, or subordinate of the manager. It means, for example, that a work within Division X, constituting the Division X work, is taken charge by Division Manager X, by Department 11 or Department 12 which is the sub-organization of Division X, or by Department Manager 11 or Department Manager 12 who is a subordinate of Division Manager X.

Next, the candidate list of the sub-work carrying-out units is displayed (step 680), and the user selects a person or organization that carries out the sub-work (step 690). Now, the sub-work carrying-out unit extracting process 510 is complete.

Through the processes as above, the carrying-out unit of the sub-work inputted in the work extracting process 110 is determined.

With the processes in steps 600 to 690, there is provided an effect that the manager of the parent work carrying-out organization, its sub-organization or the subordinate of the manager is presented as a candidate for the carrying-out unit of the sub-work item inputted in the work extracting process 110.

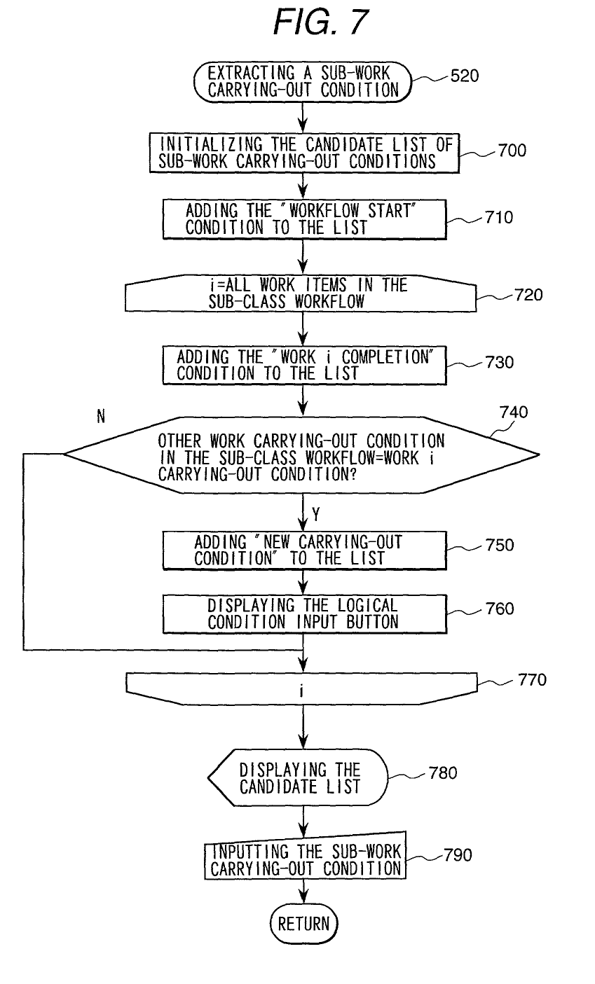

Next, FIG. 7 shows the detailed sequence of the sub-work carrying-out condition extracting process 520. The sub-work carrying-out condition extracting process 520, which is a process that determines the condition of carrying out the sub-work item inputted in the work extracting process 110, is provided with a function of defining the workflow of the sub-work independently within the sub-class and also a function of changing the user interface for inputting the carrying-out condition depending upon whether the workflow of the sub-work has a branch or not.

The process sequence is explained concretely hereunder. To start with, a list for storing the candidate carrying-out units of the sub-work is first initialized (step 700) and a “flow start” condition is added to the candidate list (step 710). The “flow start” condition is a nonobjective carrying-out condition of starting the sub-work flow, and the “flow start” condition is replaced with a combination of start conditions or completion conditions of other works on the final work support flow data (this process is executed by the work support flow generating process 120, to be explained later).

Next, for all work items in the sub-class workflow (which are called “work i”), the candidate completion conditions of work i are added to the candidate list (step 720, 730). In case there arise three sub-works, “Preparation of Order”, “Section Manager's approval on Order” and “Department Manager's approval on Order”, for example, candidate conditions such as “Preparation of Order completed”, “Section Manager's approval on Order completed” and “Department Manager's approval on Order completed” are added to the candidate list.

Next, the carrying-out condition of the work i under process is compared with the carrying-out conditions of all other sub-works (step 740).

If the carrying-out condition of the work i is equal to the carrying-out condition of other sub-work, it means that the work i and the sub-work in question are carried out together on a certain occasion and that the workflow of the sub-work contains a branch. When a workflow contains a branch, the carrying-out condition of works to be inputted after the branch may possibly be complicated. As a result, a candidate condition “New carrying-out condition” is added to the candidate list (step 750). Furthermore, a logical condition input button is additionally displayed (step 780) so that complicated work carrying-out condition can be described using a logic formula containing a combination of multiple candidate conditions. “New carrying-out condition” is a set of choices for defining a new work carrying-out condition other than “flow start” and “work i completed”. The logical condition input button is a button for inputting a logical condition “AND”, “OR”, or “NOT” among multiple candidates of the work carrying-out conditions and also for inputting brackets “(“ and ”)” used in a logic formula.

The above is explained hereunder, using an example. There can be a workflow, for example, where “Section Manager's approval on Order” or “Department Manager's approval on Order” comes after “Preparation of Order”, and the workflow requires Section Manager's approval if an article to be ordered is “stationery” and Department Manager's approval if an article to be ordered is “electric appliance”. If the carrying-out condition of “Section Manager's approval on Order” and “Department Manager's approval on Order” is simply specified like “Preparation of Order completed” in the above example, the workflow does not describe the work correctly because both works “Section Manager's approval on Order” and “Department Manager's approval on Order” are always required regardless of what article is to be ordered. When a case like the above happens, new carrying-out conditions “Order for stationery” and “Order for electric appliance” should be added, using the afore-mentioned “New carrying-out condition”, and the carrying-out condition of “Section Manager's approval on Order” is specified as “Preparation of Order completed AND Order for stationery” and the carrying-out condition of “Department Manager's approval on Order” is specified as “Preparation of Order completed AND Order for electric appliance”. For inputting this carrying-out condition, a logical condition input button “AND” is used. The detailed explanation of the user interface for inputting a logical condition will be given later.

When the steps 730 to 760 are executed completely for all work items i within the sub-class workflow (step 770), the carrying-out condition candidate list for the sub-work items inputted in the work extracting process 110 is determined.

Next, the candidate list of the sub-work carrying-out conditions is displayed (step 780), and the user selects from the candidate list and inputs the carrying-out condition of the sub-work using the logical condition input button (step 790). Now, the sub-work carrying-out condition extracting process 520 is complete.

In other words, the above means that, because the carrying-out condition of a sub-work is defined using the “flow start” condition indicating the start of the sub-class workflow, the completion condition of other work in the same sub-class workflow, the new carrying-out condition defined by the user, and a logic formula made of a combination thereof, the workflow does not depend upon the completion condition of a work in any other class but can be defined independently within the sub-class.

Through the processes as above, the carrying-out condition of the sub-work item inputted in the work extracting process 110 is determined.

With the processes in steps 700 to 790, there is provided an effect that the carrying-out condition of the sub-work item inputted in the work extracting process 110 can be defined independently within the sub-class to which the sub-work item belongs and that the work carrying-out condition inputting means is switched depending upon whether the sub-class workflow contains a branch or not.

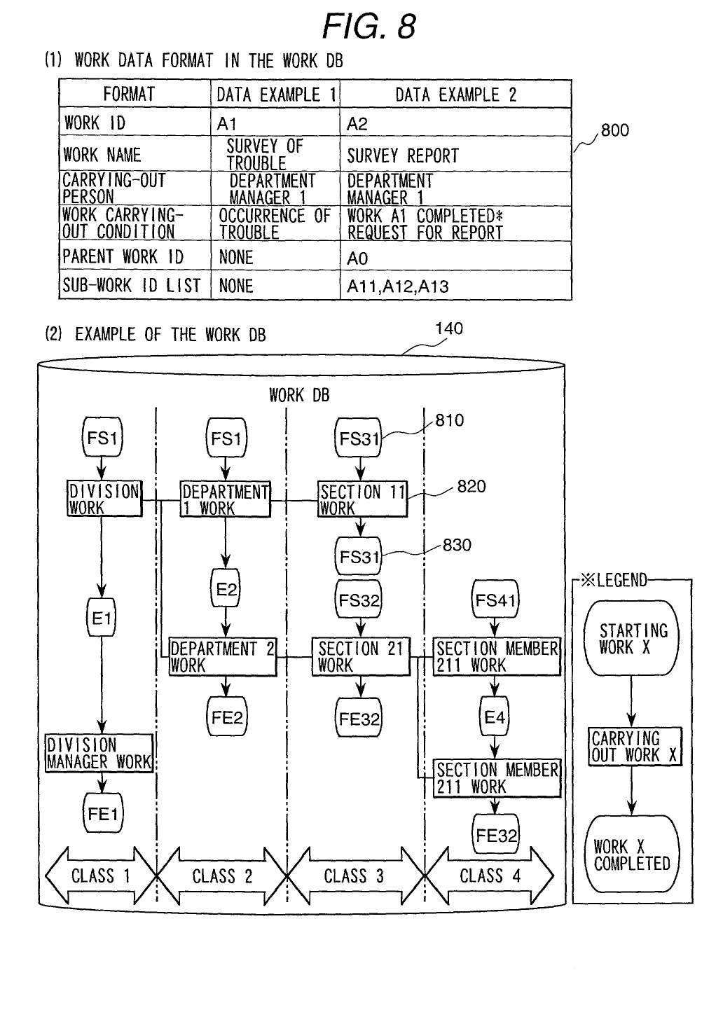

Next, FIG. 8 shows the data format of the work DB 140. Stored in the work DB 140 is the data related to the work items extracted from the user in the work extracting process 110.

FIG. 8(1) shows the format of the work data. The elements of the work data format 800 include work ID, work name, carrying-out unit, work carrying-out condition, parent work ID, and sub-work ID list, where the work ID contains an ID identifying the work item uniquely, the work name contains the work item name inputted in step 500 of the work extracting process 110, the carrying-out unit contains the work carrying-out person name or organization name extracted by the sub-work carrying-out unit extracting process 510, the work carrying-out condition contains the work carrying-out condition extracted by the sub-work carrying-out condition extracting process 520, the parent work ID contains an ID of the work which specified as the parent work in the work data, and the sub-work ID list contains a list of IDs of the works which are specified as the sub-work in the work data.

This embodiment employs the parent work ID and sub-work ID list as the data indicating the class of work, but other type of data is acceptable, For example, a pointer to the parent work data can be used in place of the parent work ID and pointers to the sub-work data can be used in place of the sub-work ID list.

In addition, although the carrying-out unit contains the work carrying-out person name or organization name in this embodiment, a staff member ID or organization ID can be used in place of the work carrying-out person name or organization name, respectively.

FIG. 8(2) shows an example of the work DB. In this example exhibiting the works carried out by the organizations in the sample staff/organization DB shown in FIG. 3(3), a square represents the work item, an ellipse represents the start or finish of the work, and an arrow represents the sequence of the work. Although, for the convenience of description, the start and stop of the work and carrying-out sequence of the work are shown separately in this example, they are held together as a work carrying-out formula in the actual work data. For example, as the carrying-out condition data FS2 is held for the Department 1 work and data E2 is held for the Department 2 work, the flow shows a sequence that the Department 2 work is carried out after the Department 1 work. Of the work start and completion conditions, the condition prefixed with FS means the workflow start condition within the class and those prefixed with FE means the workflow completion condition within the class.

With the data format as above, there is provided an effect that the work data of a class structure can be held and that the workflow data independent for each class can be held.

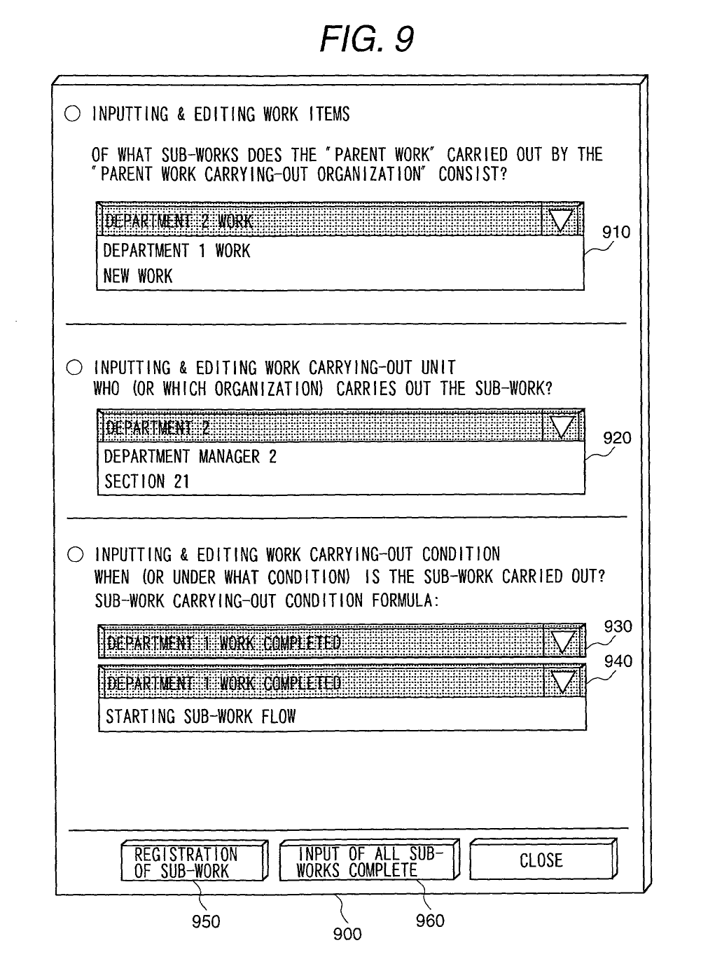

Next, FIG. 9 shows an example screen 1 of the work extracting function 110. This screen is an example of a case where the sub-class workflow contains no branch. The work data input screen 900 comprises a work item inputting area 910, work carrying-out unit selecting area 920, work carrying-out condition formula inputting area 930, and a work carrying-out condition candidate selecting area 940.

In the work item inputting area 910, the sub-class works inputted before are listed and “New work” is shown on the last line of the list. If the user writes in a new work item name, the new work item is added.

The work “parent work carrying-out organization” in the prompt is replaced dynamically with an actual parent work carrying-out organization name and the word “parent work” with an actual parent work item name, respectively. For example, if a sub-work is being inputted for the X Division work of Division X, the prompt would be “Of what sub-works does the Division X work carried out by Division X consist?”

In the work carrying-out unit selecting area 920, the candidate list of the sub-work carrying-out units generated in the sub-work carrying-out unit extracting process 510 is displayed, and the user can select a work carrying-out person or organization from the candidate list.

In the work carrying-out condition candidate selecting area 940, the list of the sub-work carrying out conditions generated in the sub-work carrying-out condition extracting process 520 is displayed. When the user selects a work carrying-out condition from the candidate list, the carrying-out condition is set in the work carrying-out condition formula inputting area 930.

When the sub-work registration button 950 is pressed after the work item, work carrying-out person or organization, and work carrying-out condition are set through the procedures above, the work data is registered in the work DB.

When the whole sub-work input completion button 960 is pressed by the user after the whole sub-works constituting the parent work are inputted, the sub-work input is complete.

With the example screen as above, there is provided an effect that the work data can be inputted in a format corresponding to the work DB format.

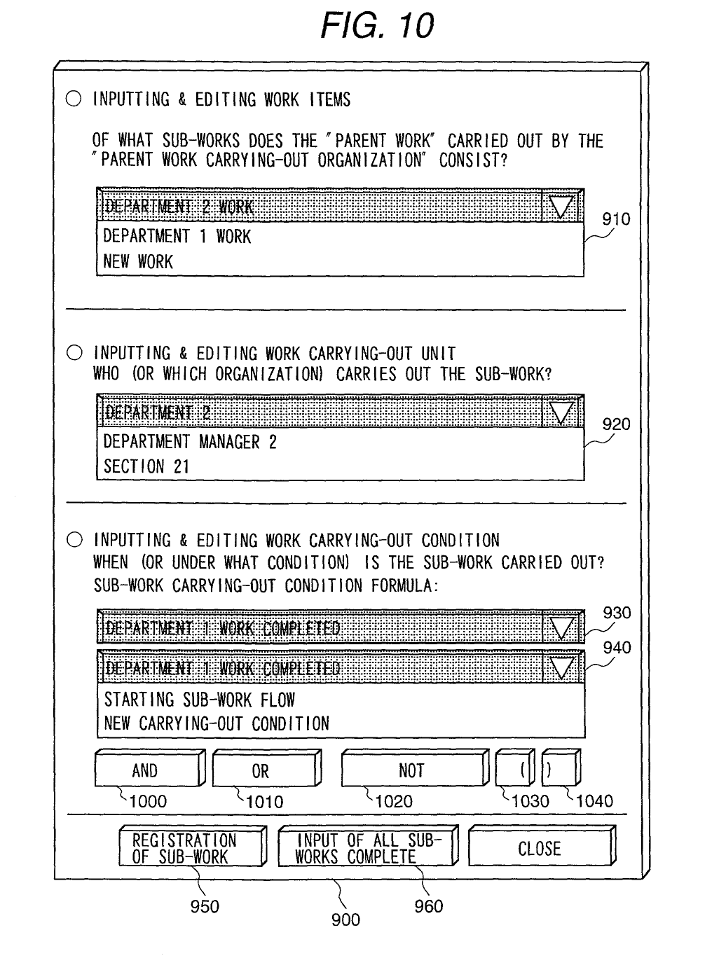

Next, FIG. 10 shows an example screen 2 of the work extracting process 110. This screen is an example of a case where the sub-class workflow contains a branch. If the sub-class workflow contains a branch, “New carrying-out condition” is added to the work carrying-out condition candidate selecting area 940 by the sub-work carrying-out condition extracting process 520 and additionally the logic condition input buttons 1000, 1010, 1020, 1030 and 1040 are displayed. As the user writes in a new carrying-out condition name over “New carrying-out condition”, the new work carrying-out condition is defined.

Besides, selecting a candidate condition from the work carrying-out condition candidate selecting area 940 and pressing necessary input buttons 1000, 1010, 1020, 1030 and/or 1040 enables to input a work carrying-out condition formula, and the inputted work carrying-out condition formula is displayed in the work carrying-out formula inputting area 930.

In the above, any means is acceptable for materializing the defined “new carrying-out condition”. For example, it is acceptable that any other work support system than in the present invention, which provides actual work support based on the work support flow data 150 according to the present invention, materializes the “new work carrying-out condition” or that the “new work carrying-out condition” is assigned to any of the works extracted according to the present invention so that the “new work carrying-out condition” can be materialized at the time when the work is completed.

With the example screen as above, there is provided an effect that the work data can be inputted in a format corresponding to the work DB format and that, if the workflow contains a branch, detailed work carrying-out condition can be inputted.

Next, FIG. 11 shows the detailed sequence of the sub-class workflow completion condition generating process 550. The sub-class workflow completion condition generating process 550 is provided with a function that generates a completion condition which specifies under what condition the sub-class workflow is completed when the sub-class work flow contains a branch.

The process sequence is explained concretely hereunder. To begin with, the work to be carried out finally in the sub-class workflow is searched among the works within the sub-class workflow (step 1100). Then, the number of the final works searched is checked (step 1100). If there are found two or more final works, it means that the sub-class workflow contains a branch in the course of the flow, and accordingly, the completion condition of the sub-class workflow cannot be defined uniquely. Because of this, the completion condition needs to be inputted by the user (step 1120). How to input the condition will be explained later. Then, the completion condition inputted by the user is registered into the workflow completion condition table, and the sub-class workflow completion condition generating process 550 is complete.

Through the processes in steps 1100 to 1130, there is provided an effect that the condition of completing the sub-class workflow in case the sub-class workflow contains a branch can be defined uniquely.

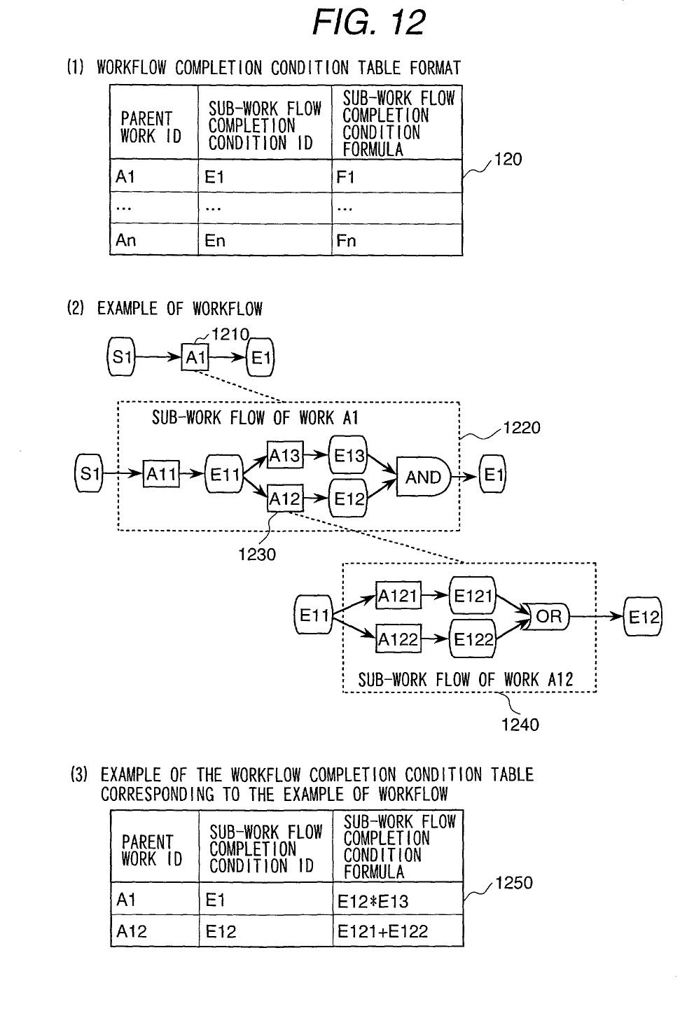

Next, FIG. 12 shows the data format of the workflow completion condition table. In the workflow completion condition table, the data related to the workflow completion condition extracted from the user in the sub-class workflow completion condition extracting process 550 is stored.

FIG. 12(1) shows the format of the workflow completion condition table. The elements of the workflow completion condition table include parent work ID, sub-work flow completion condition ID, and sub-work flow completion condition formula, where the parent work ID contains a parent work ID corresponding to the sub-class workflow, the sub-work flow completion condition ID contains an ID that can identify the sub-class workflow completion condition uniquely, and the sub-work flow completion condition formula contains a completion condition formula that brings the sub-class workflow to completion.

Next, example values that are held in the workflow completion condition table are explained hereunder, making reference to an example workflow.

FIG. 12(2) shows an example workflow. The example represents a case in which there exist a sub-work flow (1220) comprising the works A11, A12 and A13 that are sub-works of the work As (1210) and also a sub-sub-work flow comprising the works A121 and A122 that are sub-work of the sub-work A12 (1230), i.e. sub-sub-work of the work A1 (or sub-work of the work A12), where the sub-work flow of the work A1 is completed when both work A12 and work A13 are completed and the sub-work flow of the work A12 is completed when either the work A121 or the work A122 is completed.

FIG. 12(3) shows an example of the workflow completion condition table corresponding to the above-mentioned example workflow. In the example workflow above, the completion condition ID of the sub-work flow 1220 corresponding to the work A1 (1210) is E1, and the completion condition of the sub-work flow 1240 corresponding to the work A12 (1230) is E12. Since the actual completion condition of the workflow 1220 is the completion of both A12 and A13, the completion condition formula of the workflow 1220 is given as E12*E13. And, since the actual completion condition of the workflow 1240 is the completion of either A121 or A122, the completion condition formula of the workflow 1240 is given as E121+E122 (where AND is shown as symbol * and OR as symbol +).

With the data format above, there is provided an effect that the data, which uniquely represents the condition of completing the sub-class workflow in case the sub-class workflow contains a branch, can be held.

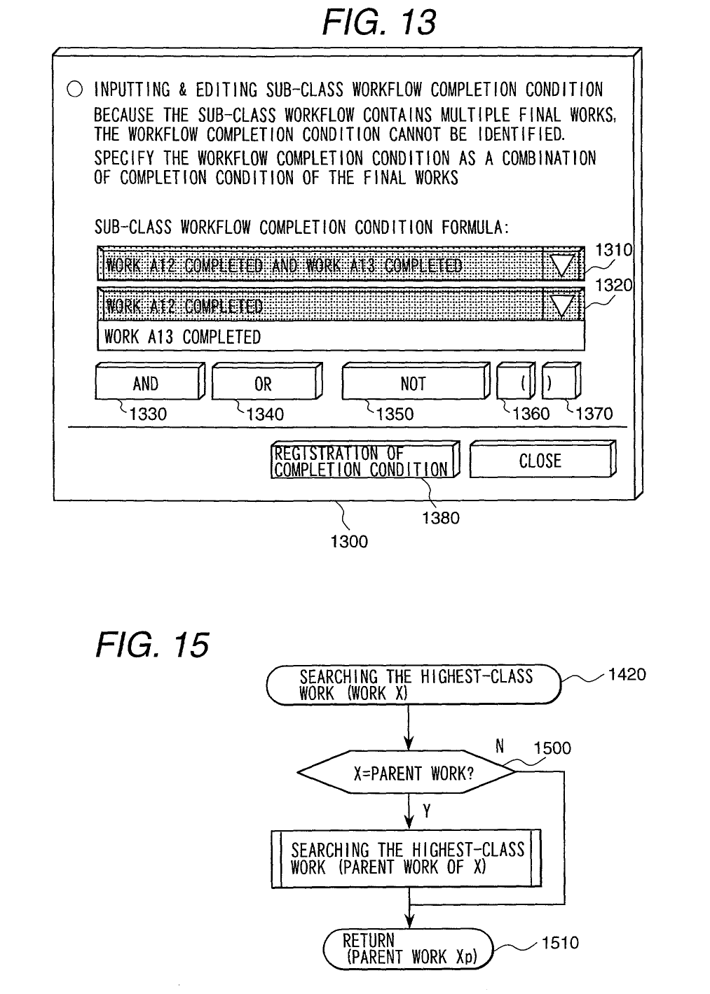

Next, FIG. 13 shows an example screen of the subclass workflow completion condition generating process 550. The sub-class workflow completion condition generating process 550 comprises a workflow completion condition inputting area 1310, workflow completion condition candidate 1320, and logic condition input buttons 1330, 1340, 1350, 1360 and 1370. In the workflow completion condition candidate 1320, the completion conditions of the final works in the subclass workflow, searched in step 1100 of the sub-class workflow completion condition generating process 550, are listed. By selecting a workflow completion condition candidate from the workflow completion condition candidate 1320 and pressing the logic condition input buttons 1000, 1010, 1020, 1030 and/or 1040 as required, the user can input a workflow completion condition formula and the inputted workflow completion condition formula is displayed in the workflow completion condition inputting area 1310.

The function and use of the logic condition input buttons are the same as for the logic condition input buttons 1000, 1010, 1020, 1030 and 1040 on the work data input screen 900.

Lastly, When the user presses the workflow completion condition registration button 1380, the inputted workflow completion condition is registered in the workflow completion condition table.

With the example screen as above, there is provided an effect that the workflow completion condition data in a format corresponding to the data format of the workflow completion condition table can be inputted when the sub-work flow contains a branch.

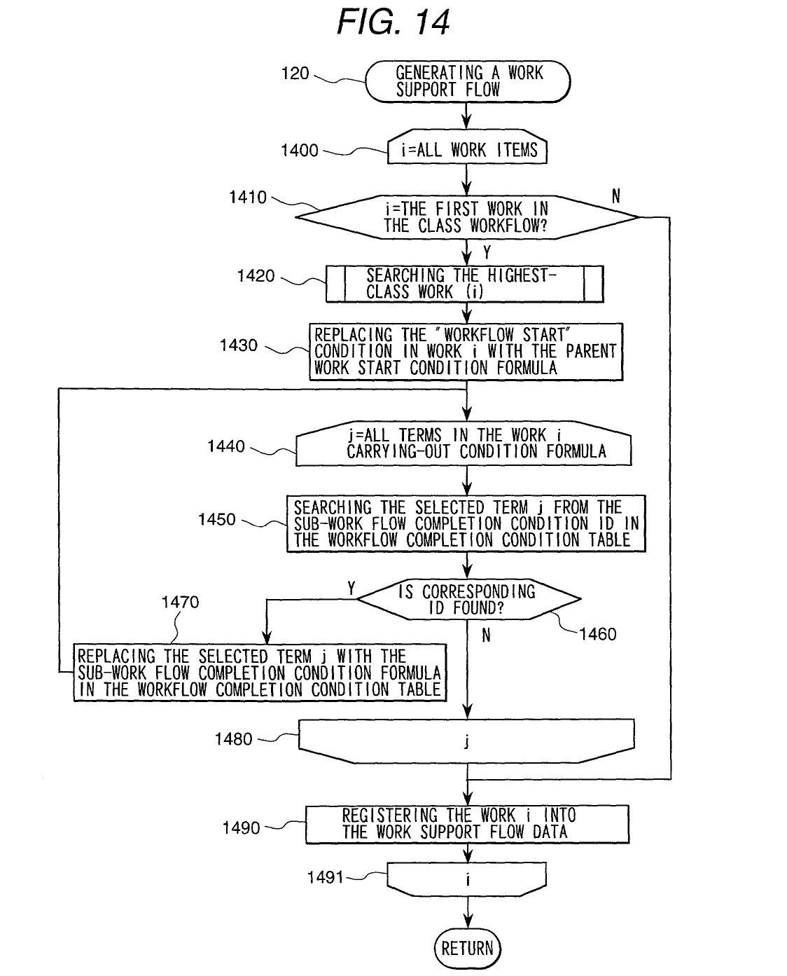

Next, FIG. 14 shows the detailed sequence of the work support flow generating process 120. The work support flow generating process 120 is provided with a function that generates the work support flow, well coordinated throughout the organization, from the work data in the work DB and the workflow, defined independently within each organizational class, in the work DB.

The concrete process sequence is explained hereunder. In the work support flow generating process 120, to start with, all the work data registered in the work DB 140 are checked to find out whether it is the first work in each class workflow (steps 1400, 1410). To be concrete, if the work carrying-out condition formula of each work i contains a “flow start” condition, the work i is judged to be the first work in the workflow of the class to which the work belongs.

If the work i is not the first work, the work i is registered into the work support flow data 150 as it is (step 1490).

Next, the highest-class work to which the work i belongs is searched (step 1420). The highest-class work searching process 1420 is a process for searching the work positioned at the highest class (having no parent work) among the works to which the work i belongs. To be more concrete, as shown in FIG. 15, a work X is checked for its parent work (step 1500) and, if the work has a parent work, the highest-class work search for the parent work is executed recursively (step 1510).

If the highest-class parent work Xp to which the work i belongs is found in step 1420, the “workflow start” condition formula of the work i is then replaced with the carrying-out condition formula of the parent work Xp (step 1430). As a result of this step, “workflow start”, which is a nonobjective carrying-out condition indicating the start of each class workflow, is replaced with the completion condition of other work.

Then, each term in the work i carrying-out condition formula (assuming that a term j is being selected) is searched from the sub-work flow completion condition ID in the workflow completion condition table (steps 1440, 1450). If a sub-work flow completion condition ID that conforms to the selected term j is found as a result of the search, the selected term j is replaced with the sub-work flow completion condition formula in the workflow completion condition table (steps 1460, 1470) and the sequence returns to step 1440. If the replaced portion in the formula is bracketed with “(“ and ”)” in this replacing process, the priority of importance given to each term of the carrying-out condition formula is maintained. Through the process above, a nonobjective condition “sub-work flow completion” is replaced with the completion condition of other work.

By executing the above steps 1450, 1460 and 1470 on all terms in the work i carrying-out condition formula, the nonobjective carrying-out conditions like “workflow start” and “workflow completion” contained in the work i carrying-out condition formula are replaced with the carrying-out condition of other existing work. The work i, of which carrying-out conditions have been replaced, is then registered in the work support flow data 150 (step 1490).

By executing the above steps 1410 to 1490 on all work data registered in the work DB 140, the work support flow data 150 applicable to multiple organizations can be generated from the workflows inputted independently within each organizational class.

Through the processes in steps 1400 to 1491 above, there is provided an effect that the work support data applicable to multiple organizational classes can be generated from the organizational class workflow, stored in the work DB and independent for each organizational class.

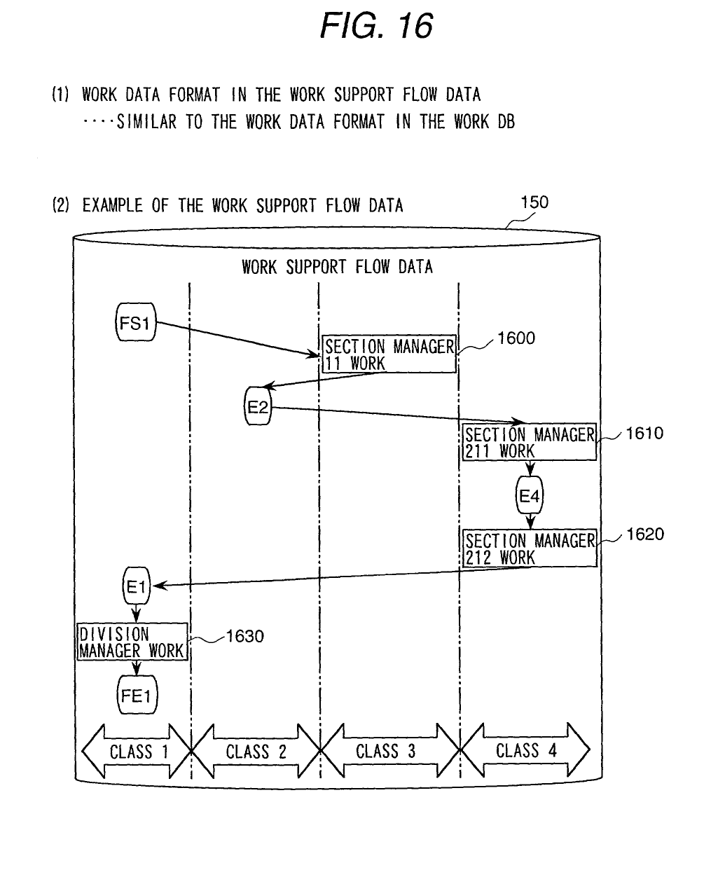

Next, FIG. 16 shows the data format of the work support flow data 150. The data related to the work support flow generated in the work support flow generating process 120 is stored in the work support flow data 150.

As shown in FIG. 16(1), the work data format of the work support flow data is the same as for the work data format of the work DB 140.

FIG. 16(2) shows an example of the work support flow data. This example shows the work support flow data that is generated as a result that the work support flow generating process 120 is executed on the work data in the example work DB shown in FIG. 8(2).

Comparing with the example work DB in FIG. 8(2), it is known that the workflow is applicable to multiple organizational classes as all “sub-work flow start” and “sub-work flow completion” conditions are deleted except for FS1 representing the work start and FE1 representing the work completion of the whole organization but, instead, each work (1600, 1610, 1620, and 1630) is started as a result of the work completion in a different class.

With the data format as above, according to the present embodiment, there is provided an effect that the work support flow data applicable to multiple organizations and classes can be held while the user simply defines the sequence within a class in replacing the data.

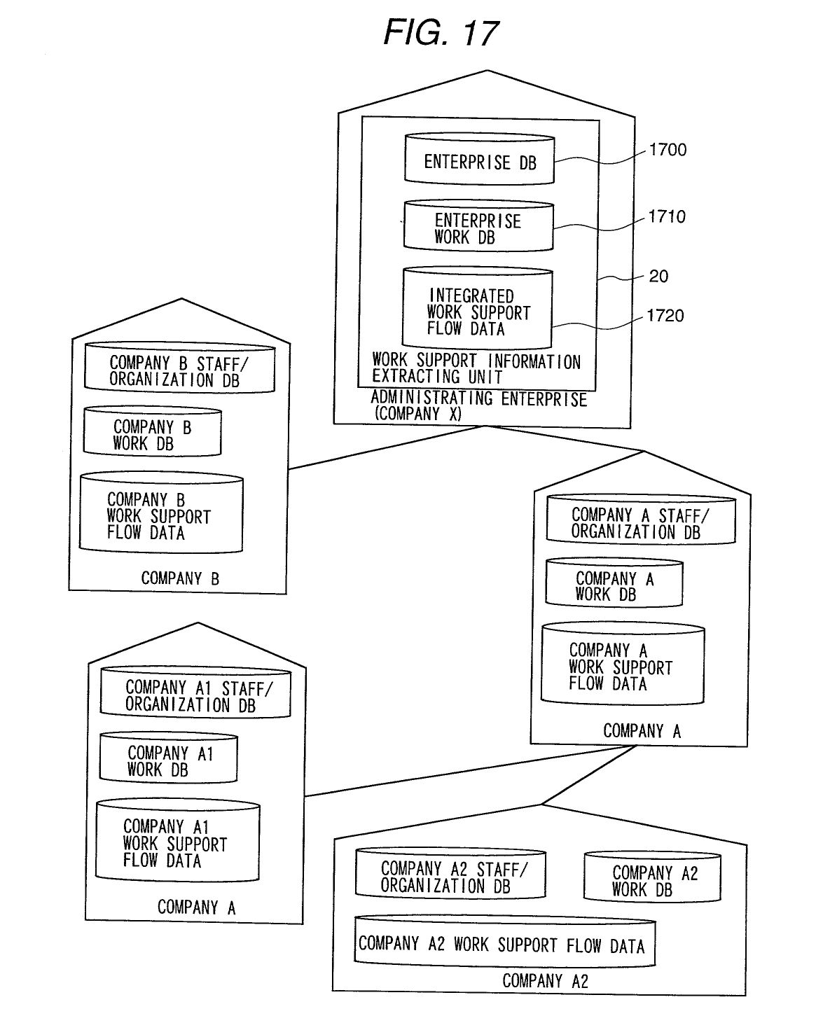

Next, the second embodiment (embodiment 2) of the work support information extracting system according to the present invention is explained hereunder, using FIG. 17 to FIG. 22.

The example explained in this embodiment is a work information extracting service that utilizes the work support information extracting system of the aforementioned embodiment 1. To be concrete, the example supposes a case where the workflow is so constructed that works are carried out jointly by four enterprises, Company A, Company B, Company A1 (subsidiary of Company A) and Company A2 (subsidiary of Company A). The construction of each unit and layout of screen in this embodiment are supposed to be similar to that in the embodiment 1.

As shown in FIG. 17, each Company A, Company B, Company A1 and Company A2 is supposed to have its own staff/organization DB, work DB and work support flow data. In addition, the work support information extracting unit 20 in the embodiment 1 is operating in the administrating enterprise (Company X) that provide the work information extracting service. The work support information extracting unit 20 of this embodiment contains an enterprise DB 1700 instead of a staff/organization DB 130, an enterprise work DB 1710 instead of a work DB 140, and an integrated work support flow data 1720 instead of a work support flow data 150. The staff/organization DB 130 and enterprise DB 1700 have the same data format, work DB 140 and enterprise work DB 1710 have the same data format, and work support flow data 150 and integrated work support flow data 1720 have the same data format, respectively. In other words, the data differs only in descriptions.

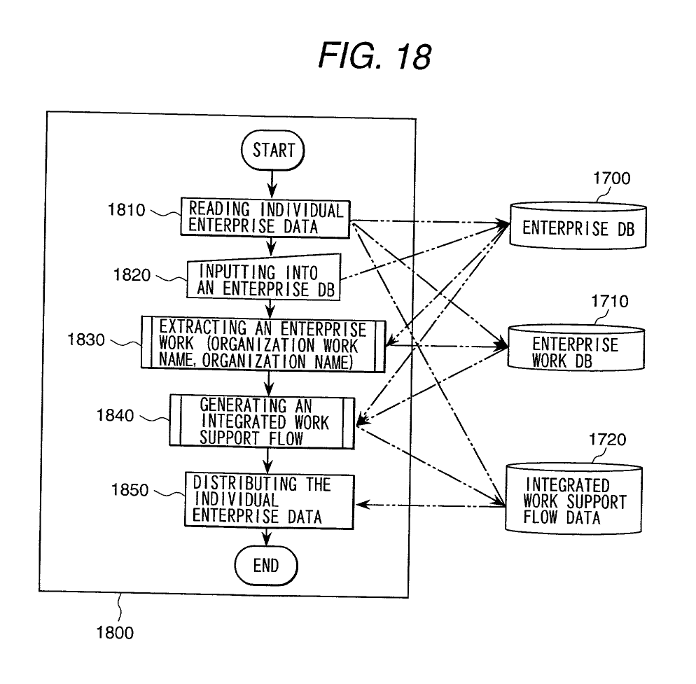

Next, FIG. 18 shows the processes in the embodiment 2. In the work support information extracting program 1800 of this embodiment, the staff/organization DB, work DB and work support flow data held independently by each enterprise is read out (step 1810). Any means of reading out the data is acceptable.

Next, an input process into the enterprise DB is executed (step 1820). Detail of this process sequence is the same as in the staff/organization inputting process 100 in the embodiment 1. In this process, Company X is registered in the enterprise DB as an administrating enterprise, and Company A, Company B, Company A1 and Company A2 are registered as the sub-organizations of Company X.

Then, an enterprise work extracting process is executed (step 1830). Detail of this process sequence is the same as in the work extracting process 110 in the embodiment 1. In this process, the administration work to be carried out by Company X is registered in the enterprise work DB so as to modify the work carrying-out conditions in each company which have already been read out in the individual enterprise data reading process 1810.

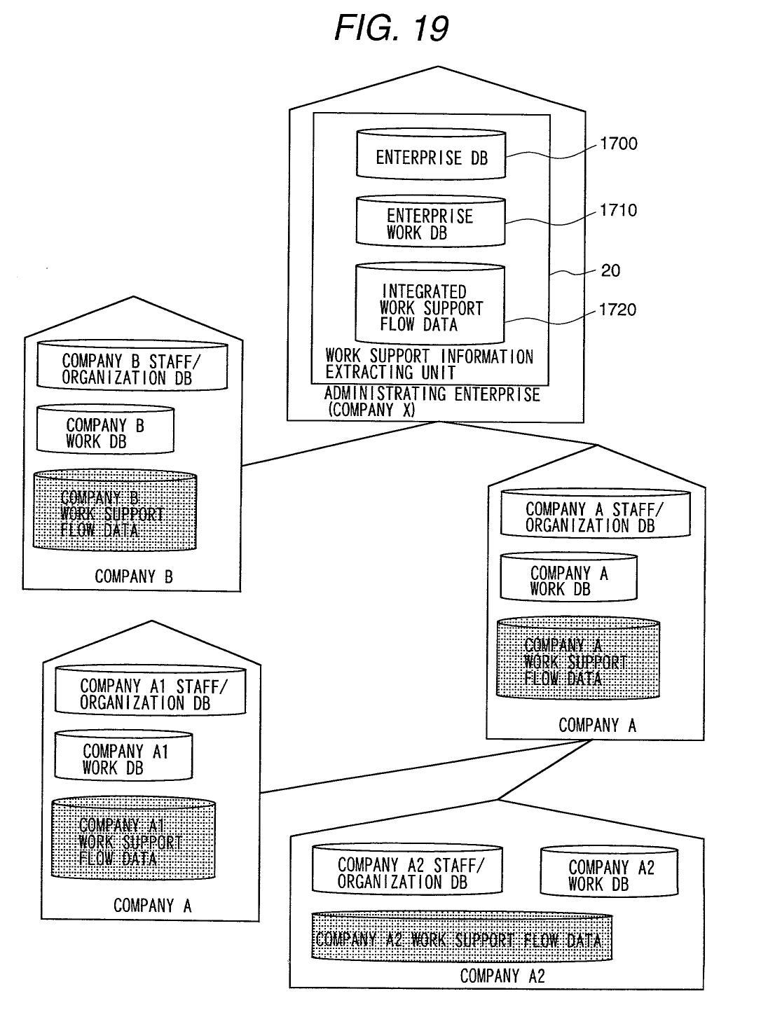

Next, an integrated work support flow generating process is executed (step 1840). Detail of this process sequence is the same as in the work support flow generating process 120 in the embodiment 1. In this process, work support flows applicable to the companies are generated. Lastly, the integrated work support flow data generated in step 1840 is subdivided into portions related to each company and distributed back to relevant enterprises (step 1850). As shown in FIG. 19, the work support flow data subdivided into portions related to each company (shaded portions) is distributed from Company X.

Any means of distribution is acceptable. For example, data may be distributed automatically through a network or by means of a medium such as FD.

Through the processes in steps 1810 to 1850, there is provided an effect that the integrated work support flow data can be generated from the staff/organization DB, work DB and work support flow data, held respectively by multiple organizations, and that the data can be subdivided for each enterprise and distributed to each.

In this service, it is allowable to charge a fee in each step of the processes in the embodiment 2. For example, in step 1810, it is allowable to charge a fee by volume of read-out data such as the staff/organization DB, work DB, work support flow data, etc.

It is also allowable that, in step 1850, a fee is charged by volume of distributed data such as the work support flow data subdivided for each company. Any means of charging basis other than volume is acceptable (for example, charge by time required for data preparation).

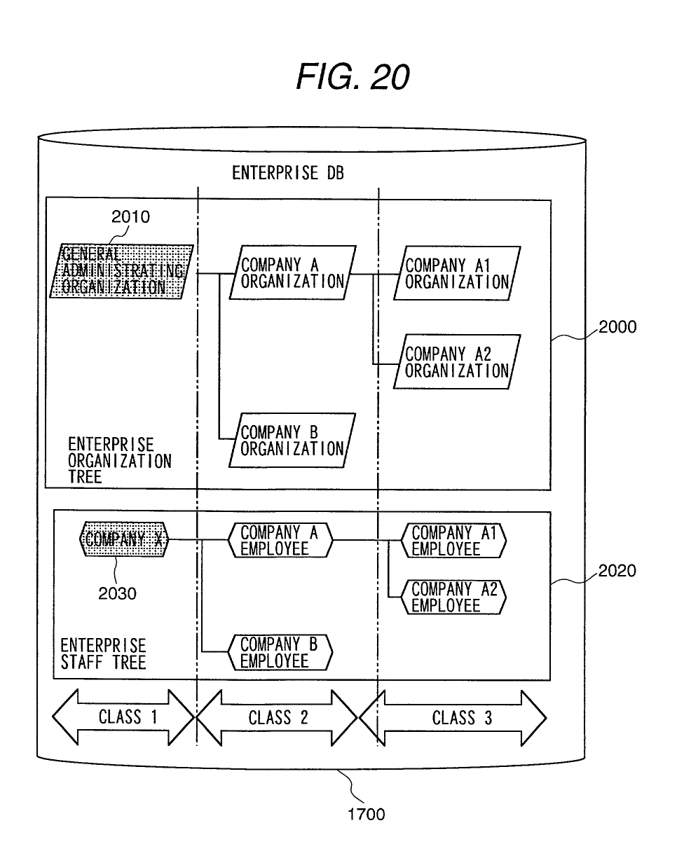

Next, FIG. 20 shows an example of the enterprise DB 1700. The enterprise DB 1700 contains an enterprise organization tree 2000 and an enterprise staff tree 2020, each having the same data structure as in the organization tree 329 and staff tree 340 in the embodiment 1, respectively. In the afore-mentioned step 1820, a general administrating organization 2010 and Company X, an administrating enterprise 2030 are added to this, and the organization and staff of each enterprise read out in the previous step 1810 are allocated.

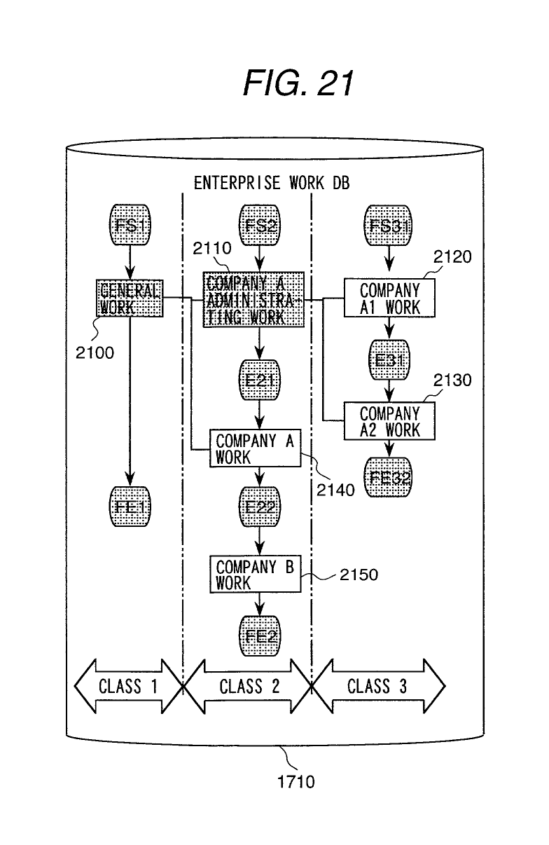

Next, FIG. 21 shows an example of the enterprise work DB 1710. The enterprise work DB 1710 has the same data structure as in the work DB 140 in the embodiment 1. In the afore-mentioned step 1830, a general work 2100 for coordinating the works of each enterprise is added, and the carrying-out sequences of the works of individual enterprise, read out in the afore-mentioned step 1810, are defined with priority applicable to multiple enterprises in each work class. In addition, if a hierarchical relation is caused among the works of different enterprises (such as subcontract of work. The example shows a case where works are subcontracted from Company A to its subsidiaries, Company A1 and Company A2), an administrating work at a higher class, such as Company A administrating work 2110, is added. In FIG. 21, the shaded portions represent the data newly defined in step 1830, and the individual enterprise works 2120, 2130, 2140, and 2150 represent the data read out in step 1810.

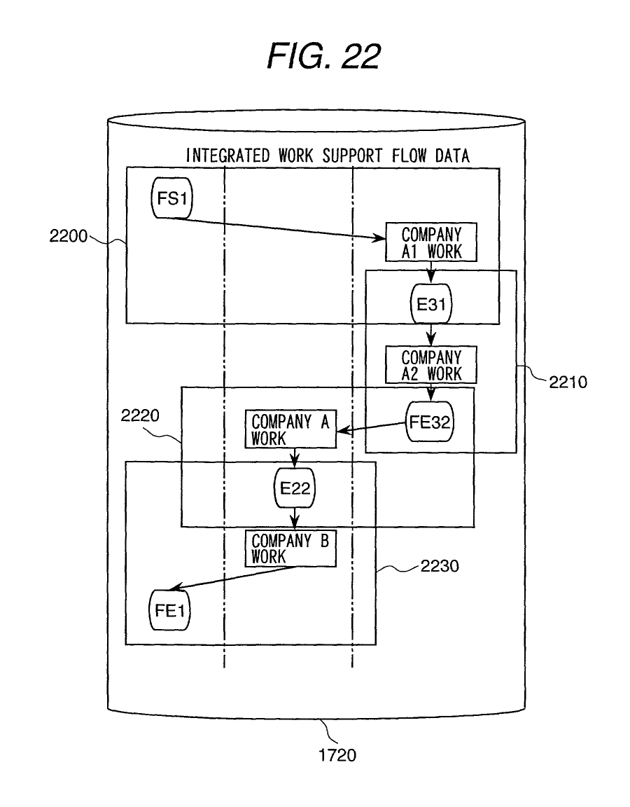

Next, FIG. 22 shows an example of the integrated work support flow data 1720 generated in the aforementioned step 1840. The integrated work support flow data 1720 has the same data structure as in the work flow data in the embodiment 1. The integrated work support flow data can be subdivided into the Company A1 work support flow 2200, Company A2 work support flow 2210, Company A work support flow 2220, and Company B work support flow 2230. Thus, the individual work support flow is distributed to each enterprise in step 1850.

Also in this embodiment, there is provided an effect that the work support flow data applicable to multiple organizations and classes can be held while the user simply defines the sequence within a class in replacing the data.

As explained above, according to the embodiment 2, it is possible to realize a service that generates, based on the staff/organization DB, work D/B and work support flow data held independently by each enterprise, the work support flow for each enterprise to carry out the work jointly.

In consideration of the performance environment of the computer that executes the processes according to the present invention, it is acceptable in the present invention that any one of the process steps in the afore-mentioned embodiments is realized after being divided into two or more steps or that two or more steps of the processes are realized after being integrated into a single step. There is no limitation to the mode of realization so long as the functions offered by the present invention are not damaged.

With the work support information extracting system according to the present invention, where there is provided a function for describing a workflow in classes, works can be extracted in a unit corresponding to a work or organization unit when the work information is extracted from the user.

Since a work support flow, well coordinated throughout the organization and applicable to multiple organizational classes, can be generated automatically simply by defining the workflow independently in each organizational class, the influence of modifying a workflow can be limited within the organization that carries out the modified work.

What is claimed is:

1. A work support information extracting program which is executed on a computer comprising a data processing unit, a storage unit containing a staff/organization database, and an input-output unit; wherein
the work support information extracting program is provided with a work extracting function that stores an inputted work database into the storage unit and a work support flow generating function that generates work support flow data from the information in the staff/organization database and work database and stores the data into the storage unit as well; and
the work support flow generating function is provided with a function that generates, from the workflows in an organizational class stored in the work database and class information stored in the staff/organization database, the work carrying-out condition information applicable to multiple organizational classes.

2. A work support information extracting program which is executed on a computer comprising a data processing unit, a storage unit containing a staff/organization database, and an input-output unit; wherein
the work support information extracting program is provided with a work extracting function that stores an inputted work database into the storage unit and a work support flow generating function that generates work support flow data from the information in the staff/organization database and work database and stores the data into the storage unit as well; and
the work extracting function is provided with a work item name inputting function that inputs the work item information corresponding to the organizational class information in the staff/organization database, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization.

3. A work support information extracting program which is executed on a computer comprising a data processing unit, a storage unit containing a staff/organization database, and an input-output unit; wherein
the work support information extracting program is provided with a work extracting function that stores an inputted work database into the storage unit and a work support flow generating function that generates work support flow data from the information in the staff/organization database and work database and stores the data into the storage unit as well;
the work extracting function is provided with a work item name inputting function that inputs the work item information corresponding to the organizational class information in the staff/organization database, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization; and
the work carrying-out unit extracting function is provided with a function that presents, as a candidate for carrying out the work item, the name of the manager of the organizational class corresponding to the work item information, names of subordinates under the manager, and names of organizations under the organizational class.

4. A work support information extracting program which is executed on a computer comprising a data processing unit, a storage unit containing a staff/organization database, and an input-output unit; wherein
the work support information extracting program is provided with a work extracting function that stores an inputted work database into the storage unit and a work support flow generating function that generates work support flow data from the information in the staff/organization database and work database and stores the data into the storage unit as well;
the work extracting function is provided with a work item name inputting function that inputs the work item information corresponding to the organizational class information in the staff/organization database, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization; and
the work carrying-out condition extracting function is provided with a function that inputs a workflow, comprising the carrying-out sequences and conditions of a single or multiple pieces of work in the organizational class, independently in the organizational class.

5. A work support information extracting program which is executed on a computer comprising a data processing unit, a storage unit, and an input-output unit; wherein
the computer is equipped with a staff/organization database;
the work support information extracting program, being executed on the computer, realizes a work extracting function that stores an inputted work database into the storage unit and a work support flow generating function that generates work support flow data from the information in the staff/organization database and work database and stores the data into the storage unit;
the work extracting function is provided with a work item name inputting function that inputs the work item information corresponding to the organizational class information in the staff/organization database, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization; and
the work carrying-out condition extracting function is provided with a function that switches a means for inputting the work carrying-out condition information depending upon whether a workflow comprising the carrying-out sequences and conditions of a single or multiple pieces of work in the organizational class contains a branch(es) or not.

6. A work support information extracting program which is executed on a computer comprising a data processing unit, a storage unit, and an input-output unit; wherein
the computer is equipped with a staff/organization database;
the work support information extracting program, being executed on the computer, realizes a work extracting function that stores an inputted work database into the storage unit and a work support flow generating function that generates work support flow data from the information in the staff/organization database and work database and stores the data into the storage unit;
the staff/organization database contains the organization information about the class structure of the organization that carries out the work and the staff information about the staff who constitutes the organization and carries out the work;
the work database contains the work item information, work carrying-out condition information that indicates the sequences and conditions of carrying[claim 6]
out the work, and work carrying-out unit information that indicates the person(s) or organization(s) in charge of carrying out the work, and also contains the work carrying-out condition information independent for each organizational class; and
the work support flow data contains the work item information, work carrying-out condition information and work carrying-out unit information and also contains the work carrying-out condition information applicable to multiple organizational classes.

7. A work support information extracting program which is executed on a computer comprising a data processing unit, a storage unit containing a staff/organization database, and an input-output unit; wherein
the work support information extracting program is provided with a work extracting function that stores an inputted work database into the storage unit and a work support flow generating function that generates work support flow data from the information in the staff/organization database and work database and stores the data into the storage unit;
the staff/organization database contains the organization information about the class structure of the organization that carries out the work and the staff information about the staff who constitutes the organization and carries out the work;
the work database contains the work item information, work carrying-out condition information that indicates the sequences and conditions of carrying out the work, and work carrying-out unit information that indicates the person(s) or organization(s) in charge of carrying out the work, and also contains the work carrying-out condition information independent for each organizational class;
the work support flow data contains the work item information, work carrying-out condition information and work carrying-out unit information and also contains the work carrying-out condition information applicable to multiple organizational classes;
the work extracting function is provided with a work item name inputting function that inputs the work item information corresponding to the organizational class information, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization;
the work carrying-out unit extracting function is provided with a function that presents, as a candidate for carrying out the work item, the name of the manager of the organizational class corresponding to the work item information, names of subordinates under the manager, and names of organizations under the organizational class;
the work carrying-out condition extracting function is provided with a function that inputs a workflow, comprising the carrying-out sequences and conditions of a single or multiple pieces of work in the organizational class, independently in the organizational class and a function that switches a means for inputting the work carrying-out condition information depending upon whether the workflow in the organizational class contains a branch(es) or not; and
the work support flow generating function is provided with a function that generates, from the workflows in an organizational class stored in the work database and class information stored in the staff/organization database, the work carrying-out condition information applicable to multiple organizational classes.

8. A work support information extracting program which is executed on a computer comprising a data processing unit, a storage unit, and an input-output unit; wherein
the work support information extracting program is provided with a staff/organization DB inputting function that stores an inputted staff/organization database into the storage unit, a work extracting function that stores an inputted work database into the storage unit, and a work support flow generating function that generates work support flow data from the information in the staff/organization database and work database and stores the data into the storage unit; and
the work support flow generating function is provided with a function that generates, from the workflows in an organizational class stored in the work database and class information stored in the staff/organization database, the work carrying-out condition information applicable to multiple organizational classes.

9. A work support information extracting program which is executed on a computer comprising a data processing unit, a storage unit, and an input-output unit; wherein
the work support information extracting program is provided with a staff/organization DB inputting function that stores an inputted staff/organization database into the storage unit, a work extracting function that inputs the work database from the input unit and stores the data into the storage unit, and a work support flow generating function that generates work support flow data from the information in the staff/organization database and work database and stores the data into the storage unit; and
the work extracting function is provided with a work item name inputting function that inputs the work item information corresponding to the organizational class information in the staff/organization database, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization.

10. A work support information extracting program which is executed on a computer comprising a data processing unit, a storage unit, and an input-output unit; wherein
the work support information extracting program is provided with a staff/organization DB inputting function that stores an inputted staff/organization database into the storage unit, a work extracting function that stores an inputted work database into the storage unit, and a work support flow generating function that generates work support flow data from the information in the staff/organization database and work database and stores the data into the storage unit;
the work extracting function is provided with a work item name inputting function that inputs the work item information corresponding to the organizational class information in the staff/organization database, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization; and
the work carrying-out unit extracting function is provided with a function that presents, as a candidate for carrying out the work item, the name of the manager of the organizational class corresponding to the work item information, names of subordinates under the manager, and names of organizations under the organizational class.

11. A work support information extracting program which is executed on a computer comprising a data processing unit, a storage unit, and an input-output unit; wherein
the work support information extracting program is provided with a staff/organization DB inputting function that stores an inputted staff/organization database into the storage unit, a work extracting function that stores an inputted work database into the storage unit, and a work support flow generating function that generates work support flow data from the information in the staff/organization database and work database and stores the data into the storage unit;
the work extracting function is provided with a work item name inputting function that inputs the work item information corresponding to the organizational class information in the staff/organization database, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization; and
the work carrying-out condition extracting function is provided with a function that inputs a workflow, comprising the carrying-out sequences and conditions of a single or multiple pieces of work in the organizational class, independently in the organizational class.

12. A work support information extracting program which is executed on a computer comprising a data processing unit, a storage unit, and an input-output unit; wherein
the work support information extracting program is provided with a staff/organization DB inputting function that stores an inputted staff/organization database into the storage unit, a work extracting function that stores an inputted work database into the storage unit, and a work support flow generating function that generates work support flow data from the information in the staff/organization database and work database and stores the data into the storage unit;
the work extracting function is provided with a work item name inputting function that inputs the work item information corresponding to the organizational class information in the staff/organization database, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization; and
the work carrying-out condition extracting function is provided with a function that switches a means for inputting the work carrying-out condition information depending upon whether a workflow comprising the carrying-out sequences and conditions of a single or multiple pieces of work in the organizational class contains a branch(es) or not.

13. A work support information extracting program which is executed on a computer comprising a data processing unit, a storage unit, and an input-output unit; wherein
the work support information extracting program, being executed on the computer, realizes a staff/organization DB inputting function that stores an inputted staff/organization database into the storage unit, a work extracting function that stores an inputted work database into the storage unit, and a work support flow generating function that generates work support flow data from the information in the staff/organization database and work database and stores the data into the storage unit;
the staff/organization database contains the organization information about the class structure of the organization that carries out the work and the staff information about the staff who constitutes the organization and carries out the work;
the work database contains the work item information, work carrying-out condition information that indicates the sequences and conditions of carrying out the work, and work carrying-out unit information that indicates the person(s) or organization(s) in charge of carrying out the work, and also contains the work carrying-out condition information independent for each organizational class; and
the work support flow data contains the work item information, work carrying-out condition information and work carrying-out unit information and also contains the work carrying-out condition information applicable to multiple organizational classes.

14. A work support information extracting program which is executed on a computer comprising a data processing unit, a storage unit, and an input-output unit; wherein
the work support information extracting program is provided with a staff/organization DB inputting function that stores an inputted staff/organization database into the storage unit, a work extracting function that stores an inputted work database into the storage unit, and a work support flow generating function that generates work support flow data from the information in the staff/organization database and work database and stores the data into the storage unit;
the staff/organization database contains the organization information about the class structure of the organization that carries out the work and the staff information about the staff who constitutes the organization and carries out the work;
the work database contains the work item information, work carrying-out condition information that indicates the sequences and conditions of carrying out the work, and work carrying-out unit information that indicates the person(s) or organization(s) in charge of carrying out the work, and also contains the work carrying-out condition information independent for each organizational class;
the work support flow data contains the work item information, work carrying-out condition information and work carrying-out unit information and also contains the work carrying-out condition information applicable to multiple organizational classes;
the work extracting function is provided with a work item name inputting function that inputs the work item information corresponding to the organizational class information, a work carrying-out unit extracting function that inputs the work carrying-out unit information, a work carrying-out condition extracting function that inputs the work carrying-out condition information, a function that registers a set of the work item information, work carrying-out unit information and work carrying-out condition information, a class workflow completion condition generating function that inputs the condition of completing the whole work in the organizational class, and a function that inputs sub-work items subdivided from the work item if the work carrying-out unit corresponding to the work item information is an organization;
the work carrying-out unit extracting function is provided with a function that presents, as a candidate for carrying out the work item, the name of the manager of the organizational class corresponding to the work item information, names of subordinates under the manager, and names of organizations under the organizational class;
the work carrying-out condition extracting function is provided with a function that inputs a workflow, comprising the carrying-out sequences and conditions of a single or multiple pieces of work in the organizational class, independently in the organizational class and a function that switches a means for inputting the work carrying-out condition information depending upon whether the workflow in the organizational class contains a branch(es) or not; and
the work support flow generating function is provided with a function that generates, from the workflows in an organizational class stored in the work database and class information stored in the staff/organization database, the work carrying-out condition information applicable to multiple organizational classes.

15. A work support information extracting system, containing a data processing unit, a storage unit, and an input-output unit, which is realized by execution of the work support information extracting program according to any one of claims 1 through 14 on the computer.

16. A work support information extracting method which is realized by execution of a work support information extracting program on a computer comprising a data processing unit, a storage unit containing a staff/organization database, and an input-output unit; wherein
a work database inputted from the input unit is stored in the storage unit;
work support flow data is generated from the information in the staff/organization database and work database, and stored in the storage unit as well; and
work carrying-out condition information applicable to multiple organizational classes is generated from the workflows in the organizational class stored in the work database and class information stored in the staff/organization database.

17. A work support information extracting method which is realized by execution of a work support information extracting program according to any one of claims 1 through 14 on a computer; comprising:
an individual enterprise data reading process for reading our the staff/organization database, work database and work support flow data from multiple organizations;
an enterprise DB inputting process for inputting an enterprise database having the same data structure as the staff/organization database according to claim 13;
an enterprise work extracting process for inputting an enterprise work database having the same data structure as the work database according to claim 13;
an integrated work support flow generating process for generating, from the information in the enterprise database and enterprise work database, the integrated work support flow data having the same data structure as the work support flow data according to claim 13; and
an individual enterprise data distributing process for breaking down the integrated work support flow data by organizations, which are read out in the individual enterprise data reading process, and distributing the data to the organizations.
